(19) United States
(12) Patent Application Publication
(10) Pub. No.: US 2024/0203642 A1
(43) Pub. Date: Jun. 20, 2024

(54) MSO COIL PROCESSING APPARATUS AND METHOD

(71) Applicant: HYUNDAI MOBIS CO., LTD., Seoul (KR)

(72) Inventors: Man Ki KIM, Yongin-si (KR); Yong CHUN, Yongin-si (KR)

(73) Assignee: HYUNDAI MOBIS CO., LTD., Seoul (KR)

(21) Appl. No.: 18/537,633

(22) Filed: Dec. 12, 2023

(30) Foreign Application Priority Data
Dec. 19, 2022 (KR) 10-2022-0177788

(51) Int. Cl. H01F 41/04; H01F 5/00

(52) U.S. Cl. CPC H01F 41/04; H01F 2005/006

(57) ABSTRACT

A processing apparatus for a maximum slot occupation (MSO) coil according to one embodiment of the present disclosure may include a jig on which a coil base material, which has an opening formed in a central portion of the coil base material in a vertical direction and is to be processed, is seated, a multi-cutter in which a plurality of blades are stacked to form horizontal slits and inclined slits in side surfaces of the coil base material seated on the jig, and a cutting tool which processes at least one of the side surfaces of the coil base material to connect the horizontal slits and the inclined slits.

### CROSS-REFERENCE TO RELATED APPLICATION

This application claims priority to and the benefit of Korean Patent Application No. 2022-0177788, filed on Dec. 19, 2022, the disclosure of which is incorporated herein by reference in its entirety.

### BACKGROUND

### 1. Field of the Invention

The present disclosure relates to a maximum slot occupation (MSO) coil processing apparatus and method, and more specifically, to an apparatus and method for forming an MSO coil of which a cross-section has a quadrangular plate shape.

### 2. Discussion of Related Art

In an electric vehicle, an electric motor is a very important apparatus which determines the performance of the electric vehicle, and recently, various methods for improving a coil space factor or conductor occupying ratio of a coil wound around a rotor or stator constituting the motor have been studied, and a method of increasing a diameter of a coil or increase the number of windings is generally used.

However, in the conventional coil, a copper wire of which a vertical cross section has a circular shape is used, and when a diameter of the circular coil increases, a waste space is generated between wound coil layers due to the circular cross section, and thus there is a fundamental problem that a coil space factor or conductor occupying ratio of the coil is reduced.

Meanwhile, when a coil having a very small diameter is wound, the number of windings increases in the same area, and thus there may be problems that efficiency is decreased and heat is generated due to a relative increase in electrical resistance. As described above, the conventional electric motor has a limitation that the efficiency and an output density cannot be improved above a certain level due to the low coil space factor or conductor occupying ratio, and thus, in order to improve the efficiency and the output density, a technology for forming a coil of which a cross section has a quadrangular plate shape, which is a maximum slot occupation (MSO) coil changed from the conventional coil of which the cross-section has the circular shape, has been developed and used.

The conventional MSO coil forming process has been performed using a computerized numerical control (CNC) and a wire. However, according to the conventional MSO coil forming process, there is a problem that the productivity of products is reduced due to an excessive processing time.

### SUMMARY OF THE INVENTION

The present disclosure is directed to providing a maximum slot occupation (MSO) coil processing apparatus and method, which may improve the productivity of products by reducing a processing time of the MSO coil compared to the conventional processing time because a coil base material is processed using a multi-cutter while the multi-cutter moves along one path.

Objectives to be solved by the present disclosure are not limited to the above-described objectives, and the other objectives which are not described above will be clearly understood by those skilled in the art from the following description.

According to an aspect of the present disclosure, there is provided an MSO coil processing apparatus including a jig on which a coil base material, which has an opening formed in a central portion of the coil base material in a vertical direction and is to be processed, is seated, a multi-cutter in which a plurality of blades are stacked to form horizontal slits and inclined slits in side surfaces of the coil base material seated on the jig, and a cutting tool which processes a side surface of the coil base material to connect the horizontal slits and the inclined slits.

The jig may include a first jig for forming the horizontal slits, on which the coil base material is seated, a second jig for forming the inclined slits, on which the coil base material is seated, and a third jig for connecting the horizontal slits and inclined slits, on which the coil base material is seated.

The first jig may include a first base plate, a first fixing plate which is installed on an upper surface of the first base plate and in which the coil base material is fixed to an upper surface of the first fixing plate, and a first cover which is installed on an upper end of the first fixing plate to pass through the opening to fix the coil base material.

The second jig may include a second base plate, a second fixing plate which is installed on an upper surface of the second base plate to be inclined and in which the coil base material is fixed to an upper surface of the second fixing plate, a support plate installed on both sides of the second fixing plate and including support legs extending between and supporting the horizontal slits, and a second cover which is installed on an upper end of the second fixing plate to pass through the opening to fix the coil base material.

The third jig may include a third base plate, a third fixing plate which is installed on an upper surface of the third base plate to stand upright and in which the coil base material is fixed to one surface of the third fixing plate, a support plate installed on both sides of the third fixing plate and including support legs extending between and supporting the horizontal slits, and a third cover installed on an upper end of the third fixing plate to pass through the opening to fix the coil base material.

A plurality of support blocks including the support legs may be detachably installed in the support plate.

Stepped parts may be formed in rear ends of the support blocks to mutually couple the support blocks.

The multi-cutter may include a first multi-cutter in which a plurality of blades for forming the horizontal slits in the side surfaces of the coil base material are stacked and a second multi-cutter in which a plurality of blades for forming the inclined slits in the side surface of the coil base material are stacked.

Eight blades may be formed to be stacked in the first multi-cutter, and three blades may be formed to be stacked in the second multi-cutter.

The opening may be formed to have a quadrangular cross section through a drawing or extrusion process.

According to another aspect of the present disclosure, there is provided an MSO coil processing method including forming an opening having a quadrangular cross section in a central portion of a coil base material in a vertical direction, forming a horizontal slit in three surfaces among side surfaces of the coil base material using a multi-cutter in which a plurality of blades are stacked, forming an inclined slit in a remaining side surface of the coil base material using the multi-cutter in which a plurality of blades are stacked, and processing the side surface of the coil base material to connect the horizontal slit and the inclined slit.

The multi-cutter may move along one path to form the horizontal slit and the inclined slit.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a view illustrating an opening formed in a maximum slot occupation (MSO) coil according to one embodiment of the present disclosure;

FIG. 2 is a view illustrating horizontal slits formed in the MSO coil according to one embodiment of the present disclosure;

FIG. 3 is a view illustrating inclined slits formed in the MSO coil according to one embodiment of the present disclosure;

FIG. 4 is a view illustrating the horizontal slits and the inclined slits which are processed to be connected in the MSO coil according to one embodiment of the present disclosure;

FIG. 5 is a view illustrating a first jig of an MSO coil processing apparatus according to one embodiment of the present disclosure;

FIG. 6 is a view illustrating a first multi-cutter of the MSO coil processing apparatus according to one embodiment of the present disclosure;

FIG. 7 is a view illustrating a process of forming horizontal slits in the MSO coil using the first multi-cutter.

FIG. 8 is a view illustrating a second jig of the MSO coil processing apparatus according to one embodiment of the present disclosure;

FIG. 9 is a view illustrating a second multi-cutter of the MSO coil processing apparatus according to one embodiment of the present disclosure;

FIG. 10 is a view illustrating a process of forming inclined slits in the MSO coil using the second multi-cutter;

FIG. 11 is a view illustrating a third jig of the MSO coil processing apparatus according to one embodiment of the present disclosure; and

FIG. 12 is a view illustrating a state in which a second support plate of the MSO coil processing apparatus supports a coil base material according to one embodiment of the present disclosure.

### DETAILED DESCRIPTION OF EXEMPLARY EMBODIMENTS

Since the present disclosure allows for various changes and numerous embodiments, specific embodiments will be illustrated in the accompanying drawings and described in the detailed description. However, this is not intended to limit the present disclosure to the specific embodiments, and it is to be appreciated that all changes, equivalents, and substitutes falling within the spirit and technical scope of the present disclosure are encompassed in the present disclosure. In the description of the embodiments, certain detailed descriptions of the related art are omitted when it is deemed that they may unnecessarily obscure the gist of the inventive concept.

While terms such as “first” and “second” may be used to describe various components, such components are not limited by the above terms. The above terms are used only to distinguish one component from another.

The terminology used herein is for the purpose of describing particular embodiments only and is not intended to limit the present disclosure. The singular forms are intended to include the plural forms, unless the context clearly indicates otherwise. In the present specification, it should be understood that the terms “comprise,” “comprising,” “include,” and/or “including,” when used herein, specify the presence of stated features, numbers, steps, operations, elements, components, and/or combinations thereof but do not preclude the presence or addition of one or more other features, numbers, steps, operations, elements, components, and/or combinations thereof.

In addition, throughout the specification, when components are “connected,” this may not only mean that two or more components are directly connected, but this may also mean that two or more components are indirectly connected through other components or are physically connected as well as electrically connected, or are one thing even referred to as different names according to positions or functions thereof.

Hereinafter, when one embodiment of a maximum slot occupation (MSO) coil processing apparatus and an MSO coil forming method according to the present disclosure will be described in detail with reference to the accompanying drawings, components which are the same or correspond to each other will be denoted by the same reference numerals, and redundant description will be omitted.

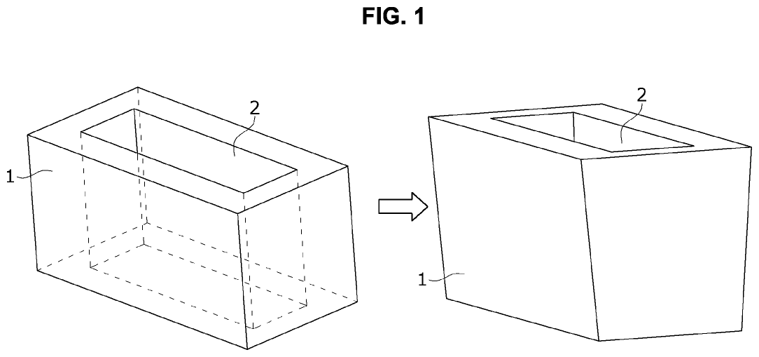

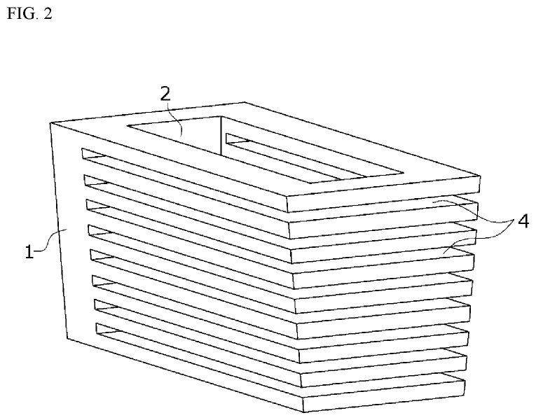

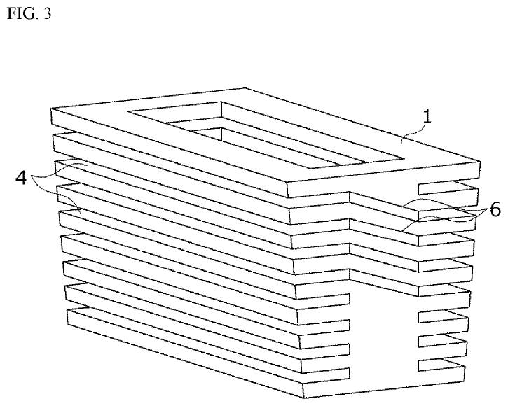

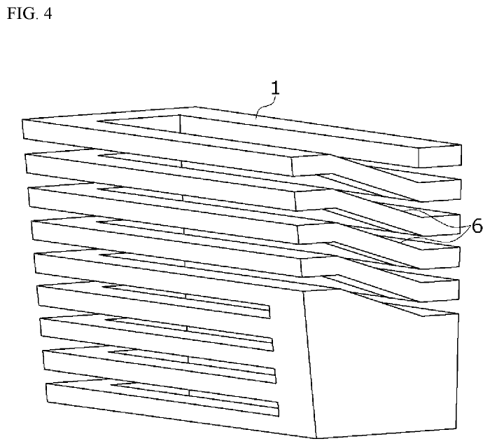

FIG. 1 is a view illustrating an opening formed in a maximum slot occupation (MSO) coil according to one embodiment of the present disclosure, and FIG. 2 is a view illustrating horizontal slits formed in the MSO coil according to one embodiment of the present disclosure. FIG. 3 is a view illustrating inclined slits formed in the MSO coil according to one embodiment of the present disclosure, and FIG. 4 is a view illustrating the horizontal slits and the inclined slits which are processed to be connected in the MSO coil according to one embodiment of the present disclosure.

First, referring to FIG. 1, an opening 2 may be formed in a coil base material 1 having a rectangular parallelepiped shape to form the MSO coil. The opening 2 is formed in a central portion of the coil base material 1 and formed in a quadrangular shape in a vertical direction through a drawing process, an extrusion process, or the like. Each surface of the coil base material 1 in which the opening 2 is formed as described above is polished, and each side wall of the coil base material 1 is processed.

Referring to FIG. 2, horizontal slits 4 may be formed in three surfaces among side surfaces of the coil base material 1 using a first multi-cutter 10 which will be described below. In this case, the horizontal slits 4 may be formed at once by the first multi-cutter 10 including a plurality of blades 12 while the first multi-cutter 10 moves in one direction.

Referring to FIG. 3, inclined slits 6 may be formed in a remaining side surface of the coil base material 1 using a second multi-cutter 20. In this case, the inclined slits 6 may also be formed at once by the second multi-cutter 20 including a plurality of blades 22 while the second multi-cutter 20 moves in one direction.

Referring to FIG. 4, the side surfaces of the coil base material 1 may be processed to connect the horizontal slits 4 and inclined slits 6 of the coil base material 1. In this case, the side surfaces of the coil base material 1 may be processed using a cutting tool (not shown). For example, a tool such as an end mill may be used as the cutting tool, but since the tool is already a known art, a specific description thereof will be omitted.

A jig for forming the MSO coil, on which the coil base material 1 is seated, may include a first jig 30 for forming the horizontal slits 4, on which the coil base material 1 is seated, a second jig 40 for forming the inclined slits 6, on which the coil base material 1 is seated, and a third jig 60 for connecting the horizontal slits 4 and inclined slits 6, on which the coil base material 1 is seated.

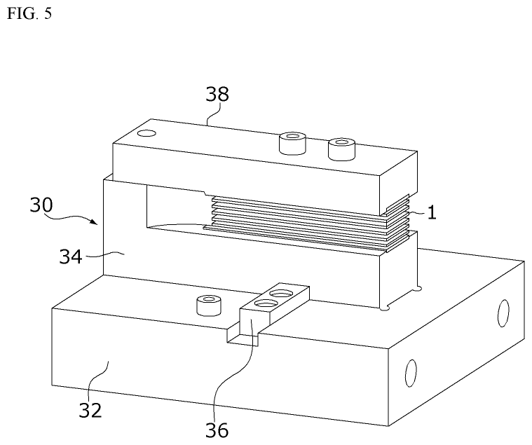

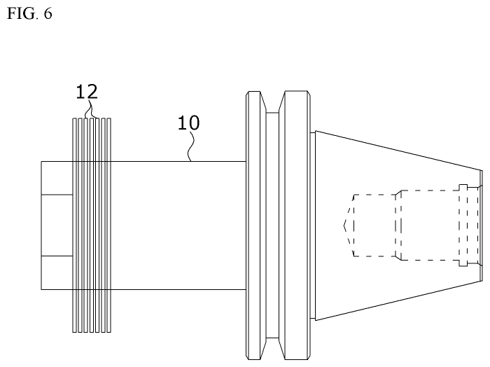

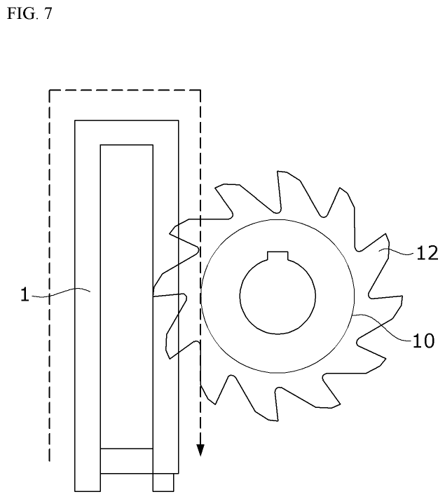

Hereinafter, a process of processing the coil base material 1 will be described based on the first jig 30, the second jig 40, and the third jig 60. FIG. 5 is a view illustrating the first jig of an MSO coil processing apparatus according to one embodiment of the present disclosure, FIG. 6 is a view illustrating the first multi-cutter of the MSO coil processing apparatus according to one embodiment of the present disclosure, and FIG. 7 is a view illustrating a process of forming the horizontal slits in the MSO coil using the first multi-cutter.

The first jig 30 may include a first base plate 32, a first fixing plate 34 which is installed on an upper surface of the first base plate 32 and in which the coil base material 1 is fixed to an upper surface of the first fixing plate 34, and a first cover 38 installed on an upper end of the first fixing plate 34 to pass through the opening 2 to fix the coil base material 1.

The first fixing plate 34 may be fixed to the upper surface of the first base plate 32 not to be moved by a first key plate 36 in a longitudinal direction. Since the first key plate 36 is slidably installed on the upper surface of the first base plate 32 of the first fixing plate 34 and inserted into a side surface of the first fixing plate 34 in a width direction, the first key plate 36 restricts movement of the first fixing plate 34 in the longitudinal direction.

The coil base material 1 may be seated on the upper surface of the first fixing plate 34, and an upper surface of the coil base material 1 may be covered by the first cover 38 and fixed to the first fixing plate 34. Accordingly, in a state in which the coil base material 1 is seated on the first jig 30, a state in which three surfaces among the side surfaces of the coil base material 1 are exposed to the outside is maintained.

In this case, the horizontal slits 4 may be formed in the side surfaces of the coil base material 1 using the first multi-cutter 10. The first multi-cutter 10 includes the plurality of blades 12 stacked on each other, and since the blades 12 are stacked as described above, the first multi-cutter 10 may process the three side surfaces of the coil base material 1 to form the horizontal slits 4 as a plurality of layers while moving along one path as illustrated in FIG. 7.

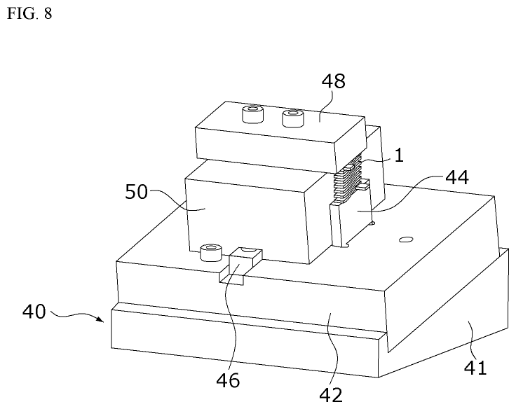

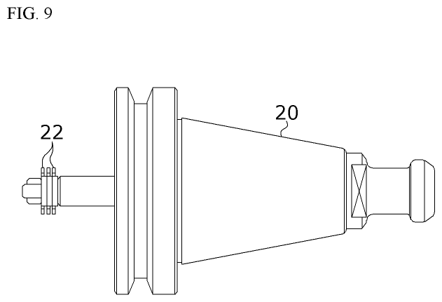

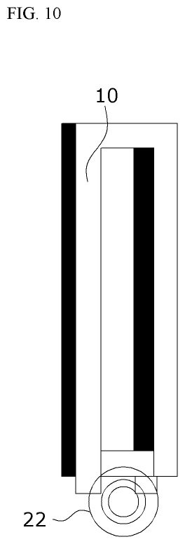

FIG. 8 is a view illustrating the second jig of the MSO coil processing apparatus according to one embodiment of the present disclosure, FIG. 9 is a view illustrating the second multi-cutter of the MSO coil processing apparatus according to one embodiment of the present disclosure, and FIG. 10 is a view illustrating a process of forming the inclined slits in the MSO coil using the second multi-cutter;

The second jig 40 may include a second base plate 42, a second fixing plate 44 which is installed on an upper surface of the second base plate 42 to be inclined and in which the coil base material 1 is fixed to an upper surface of the second fixing plate 44, a support plate 50 disposed on both sides of the second fixing plate 44 and including a support leg 54 extending between and supporting the horizontal slits 4, and a second cover 48 installed on an upper end of the second fixing plate 44 to pass through the opening 2 to fix the coil base material 1.

In the present embodiment, the second base plate 42 is installed on an upper surface of the inclined plate 41 to be inclined, the embodiment is only one example, and the second fixing plate 44 may be installed on the second base plate 42 to be inclined. It is important that the second fixing plate 44 may be installed to be inclined.

The second fixing plate 44 may be fixed to the upper surface of the second base plate 42 not to be moved by a second key plate 46 in a longitudinal direction. since the second key plate 46 is slidably installed on the upper surface of the second base plate 42 of the second fixing plate 44 and inserted into a side surface of the second fixing plate 44 in a with direction, the second key plate 46 restricts movement of the second fixing plate 44 in the longitudinal direction.

The coil base material 1 may be seated on the upper surface of the second fixing plate 44, and the upper surface of the coil base material 1 may be covered by the second cover 48 and fixed to the second fixing plate 44. In addition, the support plate 50 may be installed on both sides of the second fixing plate 44. As described above, in a state in which the coil base material 1 is seated on the second jig 40, two side surfaces of the coil base material 1 in the longitudinal direction are fixed by the support plate 50, and a state in which one surface of the coil base material 1 in a width direction is exposed to the outside is maintained.

In this case, the inclined slits 6 may be formed in the side surface of the coil base material 1 using the second multi-cutter 20. The second multi-cutter 20 includes the plurality of blades 22 stacked on each other, and since the plurality of blades 22 are stacked as described above, the second multi-cutter 20 may process one side surface of the coil base material 1 to form the inclined slits 6 as a plurality of layers while moving along one path as illustrated in FIG. 10. In addition, since the coil base material 1 is disposed to be inclined by the second fixing plate 44, the inclined slits 6 may be easily formed according to specifications by moving the second multi-cutter 20 in a horizontal direction.

As an example, eight blades 12 may be formed to be stacked in the first multi-cutter 10, and three blades 22 may be formed to be stacked in the second multi-cutter 20, and the coil base material 1 may be processed using the blades 12 and 22 of which the numbers may vary according to a thickness and the performance of the coil base material 1.

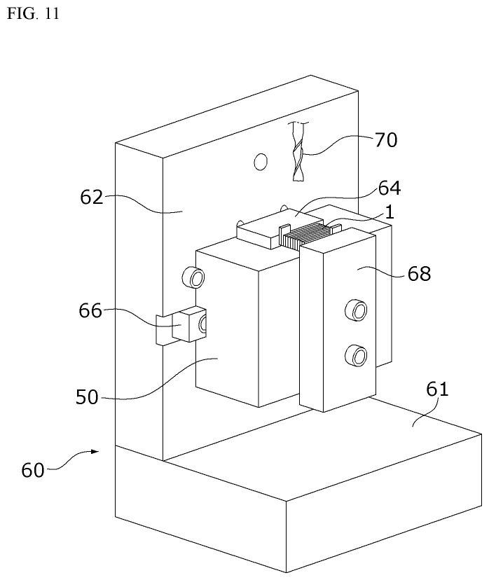

FIG. 11 is a view illustrating the third jig of the MSO coil processing apparatus according to one embodiment of the present disclosure.

The third jig 60 includes a third base plate 62, a third fixing plate 64 which is installed on an upper surface of the third base plate 62 to stand upright and in which the coil base material 1 is fixed to one surface of the third fixing plate 64, a support plate 50 installed on both sides of the third fixing plate 64 and including a support leg 54 extending between and supporting the horizontal slits 4, and a third cover 68 disposed on an upper end of the third fixing plate 64 to pass through the opening 2 to fix the material base 1.

In the present embodiment, the third base plate 62 is installed on an upper surface of the horizontal plate 61 to stand upright, but the embodiment is only one example, and the third base plate 62 may also be formed integrally with the horizontal plate 61.

The third fixing plate 64 may be fixed to one surface of the third base plate 62 not to be moved by a third key plate 66 in a longitudinal direction. Since the third key plate 66 is slidably installed on one surface of the third base plate 62 of the third fixing plate 64 and inserted into a side surface of the third fixing plate 64 in a width direction, the third key plate 66 restricts movement of the third fixing plate 64 in the longitudinal direction.

The coil base material 1 may be seated on one surface of the third fixing plate 64, and the upper surface of the coil base material 1 may be covered by the third cover 68 and fixed to the third fixing plate 64. The support plate 50 may be installed on both sides of the third fixing plate 64. As described above, in a state in which the coil base material 1 is seated on the third jig 60, both side surfaces of the coil base material 1 in the longitudinal direction are fixed by the support plates 50, and a state in which one surface (the upper surface) of the coil base material 1 in the width direction 1 is exposed to the outside is maintained.

In this case, the horizontal slits 4 and the inclined slits 6 formed on the side surfaces of the coil base material 1 may be processed to be connected using a cutting tool. In this case, as described above, a tool such as an end mill may be used as the cutting tool.

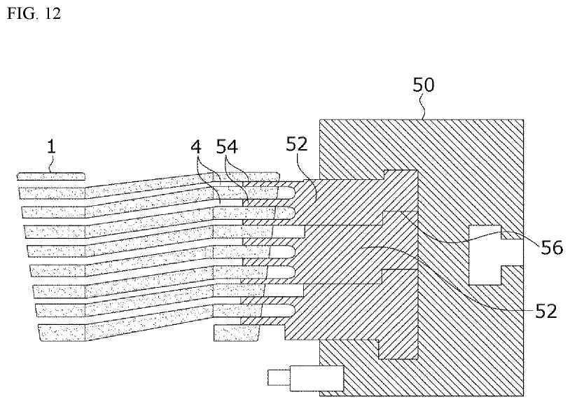

FIG. 12 is a view illustrating a state in which the second support plate of the MSO coil processing apparatus supports the coil base material according to one embodiment of the present disclosure.

Referring to FIG. 12, the support plate 50 serves to prevent the coil base material 1 from moving due to spaces formed between the slits 4 and 6 when the coil base material 1 in which the slits 4 and 6 are formed is fixed, and allows the coil base material 1 to be processed in a state in which the coil base material 1 is stably supported.

A plurality of support blocks 52 may be detachably installed in the support plate 50. That is, the plurality of support blocks 52 may be installed in the support plate 50 to be stacked on each other and may be variously stacked according to a size or the like of the coil base material 1 to serve a support function.

A plurality of support legs 54 may extend to protrude from a front surface of the support blocks 52. The support legs 54 are inserted between the horizontal slits 4 to support the coil base material 1. A thickness of each of the support legs 54 may be appropriately designed according to a layer spacing of the coil base material 1. In addition, a rear surface of the support plate 50 may be supported by a cylinder or the like and moved forward or backward to support the coil base material 1. Meanwhile, stepped parts 56 may be formed at rear ends of the support blocks 52 to mutually connect the support blocks 52.

According to one embodiment of the present disclosure, since a coil base material is processed by a multi-cutter while the multi-cutter moves along one path, the processing time of an MSO coil can be reduced compared to the conventional case, and thus the productivity of products can be improved.

While the present disclosure has been described above with reference to exemplary embodiments, it may be understood by those skilled in the art that various modifications and changes of the present disclosure may be formed within a range not departing from the spirit and scope of the present disclosure defined by the appended claims.

What is claimed is:

1. A maximum slot occupation (MSO) coil processing apparatus comprising:
a jig on which a coil base material is seated, wherein the coil base material has an opening formed in a central portion of the coil base material in a vertical direction and is to be processed;
a multi-cutter in which a plurality of blades are stacked to form horizontal slits and inclined slits in side surfaces of the coil base material seated on the jig; and
a cutting tool which processes at least one of the side surfaces of the coil base material to connect the horizontal slits and the inclined slits.

2. The apparatus of claim 1, wherein the jig includes:
a first jig configured to form the horizontal slits, on which the coil base material is seated;
a second jig configured to form the inclined slits, on which the coil base material is seated; and
a third jig configured to connect the horizontal slits and inclined slits, on which the coil base material is seated.

3. The apparatus of claim 2, wherein the first jig includes:
a first base plate;
a first fixing plate installed on an upper surface of the first base plate the coil base material fixed to an upper surface of the first fixing plate; and
a first cover installed on an upper end of the first fixing plate to pass through the opening to fix the coil base material to the upper surface of the first fixing plate.

4. The apparatus of claim 2, wherein the second jig includes:
a second base plate;
a second fixing plate installed on an upper surface of the second base plate to be inclined the coil base material fixed to an upper surface of the second fixing plate;
a support plate installed on both sides of the second fixing plate and including support legs extending between and supporting the horizontal slits; and
a second cover installed on an upper end of the second fixing plate to pass through the opening to fix the coil base material to the upper surface of the second fixing plate.

5. The apparatus of claim 2, wherein the third jig includes:
a third base plate;
a third fixing plate installed on a side surface of the third base plate to stand upright, the coil base material fixed to one surface of the third fixing plate;
support plates installed on both sides of the third fixing plate and including support legs extending between and supporting the horizontal slits; and
a third cover installed on an side end of the third fixing plate to pass through the opening to fix the coil base material to the one surface of the third fixing plate in a direction perpendicular to the vertical direction.

6. The apparatus of claim 4, wherein a plurality of support blocks including the support legs are detachably installed in the support plate.

7. The apparatus of claim 6, wherein stepped parts are formed in rear ends of the support blocks to mutually couple the support blocks.

8. The apparatus of claim 1, wherein the multi-cutter includes:
a first multi-cutter in which a plurality of blades configured to form the horizontal slits in the side surfaces of the coil base material are stacked; and
a second multi-cutter in which a plurality of blades configured to form the inclined slits in the side surface of the coil base material are stacked.

9. The apparatus of claim 8, wherein:
the plurality of blades configured to form the horizontal slits include eight blades which are formed to be stacked in the first multi-cutter; and
the plurality of blades configured to form the inclined slits include three blades which are formed to be stacked in the second multi-cutter.

10. The apparatus of claim 1, wherein the opening is formed to have a quadrangular cross section through a drawing or extrusion process.

11. A maximum slot occupation (MSO) coil processing method comprising:
forming an opening having a quadrangular cross section in a central portion of a coil base material in a vertical direction;
forming a horizontal slit in three side surfaces among side surfaces of the coil base material using a multi-cutter in which a plurality of blades are stacked;
forming an inclined slit in a remaining side surface of the side surfaces of the coil base material using the multi-cutter in which the plurality of blades are stacked; and
processing at least one of the side surfaces of the coil base material to connect the horizontal slit and the inclined slit.

12. The method of claim 11, wherein the multi-cutter moves along one path to form the horizontal slit and the inclined slit.

13. The apparatus of claim 5, wherein a plurality of support blocks including the support legs are detachably installed in the support plate.
